(19) United States
(12) Patent Application Publication
(10) Pub. No.: US 2006/0232606 A1
(43) Pub. Date: Oct. 19, 2006

(54) Method of transmitting signal for indicating opening or shuttering of a shutter in a private image display device

(75) Inventors: Jun-Sik Kim, Daejon-si (KR); Sang-Bin Yim, Daejon-si (KR); Byung-Sung Kim, Daejon-si (KR)

Correspondence Address: THE MAXHAM FIRM, 750 "B" STREET, SUITE 3100, SAN DIEGO, CA, 92101, US

(73) Assignee: Nexvi Corporation, Daejon (KR)

(21) Appl. No.: 10/544,734

(22) PCT Filed: Feb. 13, 2004
(86) PCT No.: PCT/KR04/00288

§ 371 Date: Apr. 3, 2006

(30) Foreign Application Priority Data
Feb. 14, 2003 (KR) 10-2003-0009276

(51) Int. Cl. G09G 5/00

(52) U.S. Cl. 345/620

(57) ABSTRACT

A method of transmitting a shutter opening/closing signal in a private image display device. In the method of the present invention, a shutter opening/closing sequence time point generated by a shutter opening/closing sequence time point generated by a shutter opening/closing sequence and signal generating unit is synchronized with a time point of the timer. The shutter opening/closing signal is transmitted to the transmission unit prior to the shutter opening/closing sequence time point by a predetermined period. The shutter opening/closing signal is transmitted from the transmission unit to the reception unit at a predetermined time point of the time. According to the present invention, there is an advantage in that a user visual perception performance can be improved by overcoming a transmission delay occurring when the shutter opening/closing signal is transmitted from the private image display device to the shutter device.

### TECHNICAL FIELD

The present invention relates, in general, to a device and method for displaying a private image and, more particularly, to a device and method for displaying a private image, which prohibits an unauthorized user from viewing the private image in a public display.

### BACKGROUND ART

Portable terminals, such as mobile phones, Personal Digital Assistants (PDAs) and notebook computers, and desktop Personal Computers (PCs) are frequently utilized in public places. At this time, contents on display monitors can be viewed by all the persons located within visible distances from the display monitors. Due to such a security problem, when a computer is used for the writing of text, mail, chatting or video watching and a user does not want other persons to view the contents thereof, the use of a computer is limited. A privacy problem may arise not only when computers are privately used but also when confidential documents are written using computers in corporations or government offices. Besides, the security problem exists in various fields.

In the present specification, a single display screen distinguished by the vertical sync of a monitor is referred to as a monitor frame, and a section of image data is referred to as an image data frame. The size of a single image data frame may be identical with or different from that of a single monitor frame. A private image (hereinafter referred to as a “P image”) is the private, non-public image of an authorized user. A masking image (hereinafter referred to as an “M image”) is an image that blocks the P image of an authorized user.

A private display for protecting private information using shutter glasses is currently being implemented. Since this private display is inexpensive, is light to put on and can be developed further, this scheme is regarded as the most competitive method currently. The private display should fulfill all three performance conditions, including ‘user visual perception performance,’ ‘naked eye security performance’ and ‘anti-peeper security performance.’ The ‘user visual perception performance’ is the performance that allows an authorized user to clearly view an image without visual inconvenience or fatigue, the ‘naked eye security performance’ is the performance that prevents unauthorized persons having no shutter from clearly viewing an image, and the ‘anti-peeper security performance’ is the performance that prevents unauthorized persons or intentional peepers having a shutter from clearly viewing an image.

A private display can be widely used for a variety of monitor display devices, such as a desktop PC, a notebook computer, a PDA, a mobile phone, a Television (TV), a Digital Versatile Disk (DVD), an Automatic Teller Machine (ATM)/Cash Dispenser (CD), and a door lock information input device. The basic configuration of an embodiment of the private display applied to a notebook computer is shown in FIG. 1. As shown in this drawing, the embodiment includes a computer 104 equipped with monitor 102, a shutter opening/closing means 106 performing optical filtering, a wired and wireless communication means 108 connecting the computer 104 with the shutter opening/closing means 106, and private display software (not shown). The computer 104 may include the private display software by storing the private display software in computer-readable memory. The computer 104 allows only authorized persons to view a private image in such a way as to display the private image and a masking image for masking the private image on the monitor 102 in response to a user's request or spontaneously, and to transmit a shutter opening/closing signal to the shutter opening/closing means 106 and thus operate the shutter opening/closing means 106. In this case, the computer 104 collectively refers to a variety of information devices that display images on monitors, such as a desktop monitor, a notebook computer, an PDA, a mobile phone, a TV, a DVD, an ATM/CD, and a door lock information input device.

The shutter opening/shutting means 106 may be a mechanical means, or a photoelectric means, such as a liquid crystal shutter. The shutter opening/closing means 106 may be fabricated in various forms, such as glasses having one or more shutter lenses, a shutter structure having a support, or a shutter cap. FIG. 1 illustrates a shutter opening/closing means in a shutter glasses form.

In the present specification, a shutter opening/closing sequence status value (status information) is a value quantitatively indicating the opened or closed degree of a shutter, and a shutter opening/closing sequence is the sequence of shutter opening/closing status values corresponding to an image sequence, which is expressed as [0, 1, 0, 0, 1, 0]. A shutter opening/closing sequence time point, representing a time point when the shutter must be ideally operated according to the shutter opening/closing sequence, is generated by the computer. An actual shutter opening/closing time point represents a time point when a shutter opening/closing operation actually occurs in the shutter. The shutter opening/closing signal is a signal to be transmitted to control the opening or closing operation of the shutter depending on the shutter opening/closing sequence, which generally includes one or more shutter opening/closing sequence status values.

A plurality of schemes are used to transmit a shutter opening/closing signal in a wired/wireless manner. In the scheme of Sun Microsystems disclosed in U.S. Pat. No. 5,629,984, since a shutter opening/closing signal is transmitted at every shutter opening/closing sequence time point in synchronization with the vertical synchronizing pulse of a monitor, a peeper can easily intercept and detect the shutter opening/closing sequence time point. Further, since a shutter opening/closing sequence is repetitive and periodic, it can be easily decrypted by a peeper. Moreover, the shutter opening/closing signal is transmitted to a shutter without being encrypted, thus enabling a peeper to more easily intercept the shutter opening/closing signal.

Further, in the scheme of IBM disclosed in GB. Pat. No. 2360414A, display times for P/M image frames are varied to prevent a peeper from intercepting the display times. Further, a plurality of shutter opening/closing sequence status values and image frame display times obtained for a specific period are bundled and encrypted as shutter opening/closing signals, and then transmitted to a shutter. The shutter decrypts the encrypted information and synchronizes the decrypted shutter opening/closing sequence status values and image frame display times with the data synchronizing signals of the image frames using a timer provided in the shutter, thus prohibit a peeper from intercepting and decrypting shutter opening/closing information. Even in the case of an asynchronous scheme, such as the IBM scheme, since image frames are implemented so that P images and M images are repeatedly changed, there is a high probability that a peeper can view a private image through tuning. In order to perform the encryption, transmission and synchronization of a shutter opening/closing signal, a timer is required in the shutter of a reception unit, thus increasing shutter production costs, and increasing the power consumption of a shutter in the case of a wireless shutter.

Further, the above two schemes cannot consider shutter opening/closing signal transmission delays between a host computer and a transmission unit. Transmission delays include a transmission delay between a computer and a transmission unit, and a transmission delay between the transmission unit and a reception unit. Generally, the transmission delay between the transmission and reception units is insignificant regardless of wired/wireless transmission, but the transmission delay between the host computer and the transmission unit may increase according to situations. If the operating system of the computer is not a real time operating system, such as MS Windows XP, 2000 and 9x, a transmission delay occurs. If a connection between the computer and the transmission unit is established in a packet transmission manner as in a Universal Serial Bus (USB), an additional transmission delay occurs. In this case, the real-timeness of the operating system represents ability to process a hardware interrupt in real time.

### DISCLOSURE OF THE INVENTION

Accordingly, the present invention has been made keeping in mind the above problems occurring in the prior art, and an object of the present invention is to provide a method of transmitting a shutter opening/closing signal, which transmits the shutter opening/closing signal from a private image display device to a shutter device so as to have anti-peeper security performance.

Another object of the present invention is to provide a method of transmitting a shutter opening/closing signal, which transmits the shutter opening/closing signal from a private image display device to a shutter device so as to overcome a transmission delay and obtain an excellent user visual perception performance.

In order to accomplish the above and other objects, the present invention provides a method of transmitting a shutter opening/closing signal, the method transmitting the shutter opening/closing signal between a private image display device having a transmission unit, a shutter opening/closing sequence and signal generating unit and a monitor, and a shutter having a reception unit, comprising the shutter opening/closing sequence and signal generating unit generating a shutter opening/closing signal depending on an image sequence for a private image and a masking image, the shutter opening/closing sequence and signal generating unit transmitting the shutter opening/closing signal to the transmission unit, transmitting vertical or horizontal synchronizing signals input to the monitor to the transmission unit, and the transmission unit synchronizing the shutter opening/closing signal with at least one of the input synchronizing signals and transmitting the synchronized shutter opening/closing signal to the reception unit.

The present invention is advantageous in that, if a shutter opening/closing signal is transmitted from a private image display device to a shutter device, anti-peeper security performance is improved. Further, the present invention is advantageous in that a user visual perception performance can be improved by overcoming a transmission delay occurring when the shutter opening/closing signal is transmitted from the private image display device to the shutter device.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing the construction of a system to which the present invention is applied;

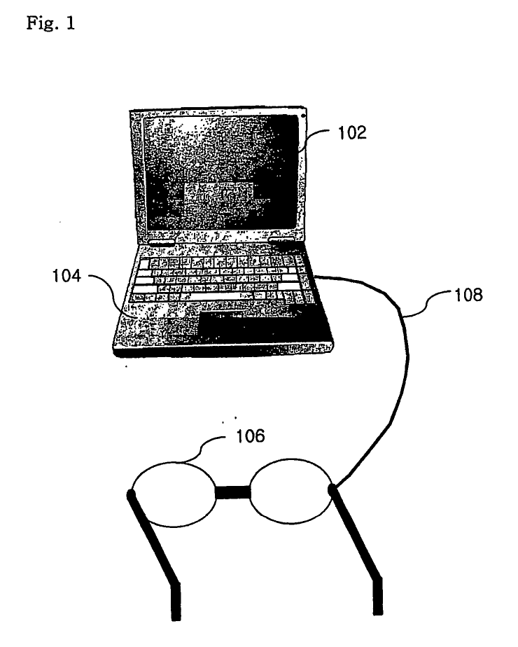

FIG. 2 is a block diagram showing the detailed construction of the system according to the present invention;

FIGS. 3a to 3c are signal waveform diagrams showing a method of transmitting a shutter opening/closing signal according to an embodiment of the present invention;

FIG. 4 is a block diagram showing a system for compensating for a transmission delay using a monitor synchronizing signal according to the present invention;

FIG. 5 is a block diagram of a system for compensating for a transmission delay using a timer of a transmission unit according to the present invention;

FIG. 6 is a block diagram of a system for compensating for a transmission delay using a timer of a reception unit according to the present invention;

FIGS. 7a to 7d are signal waveform diagrams showing a method of compensating for a transmission delay according to the present invention;

FIG. 8 is a flowchart of a method of compensating for a transmission delay using a timer of a transmission unit according to the present invention;

FIGS. 9a and 9b are signal waveform diagrams showing a method of synchronizing a time point of the timer of the transmission unit according to the present invention; and

FIGS. 10a to 10d are signal waveform diagrams showing a method of synchronizing the time point of the timer of the transmission unit using difference compensation according to the present invention.

### BEST MODE FOR CARRYING OUT THE INVENTION

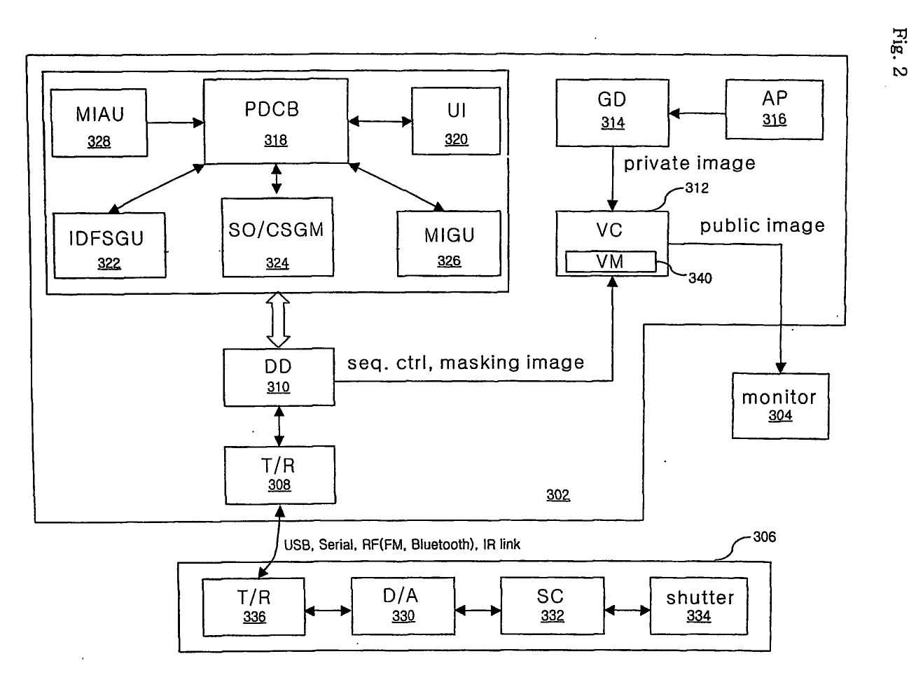

FIG. 2 is a block diagram showing the detailed construction of a system according to the present invention, in which the system uses a software method-dedicated driver. The software method imports that all functions, except the functions of a shutter opening/closing means 306 and a transmission unit 308, are implemented using software. A dedicated driver 310 refers to a driver that accesses a video controller 312, such as a graphic card, and implements private display in real time, independent of a graphic driver 314 in a PC 302.

A private display control block 318 is composed of a security performance control unit, an encryption unit, a user authentication unit and a management unit. The private display control block 318 authenticates a user accessed through a user interface 320, and sets and manages a security level depending on a user's authentication level and a user's input. A method of authenticating the user may be implemented in such a way that the identification number (hereinafter referred to as an “ID) and the password of the user are input through the user interface 320 and then the user is authenticated on the basis of the ID and password. In another embodiment, the user authentication may be implemented in such a way as to connect an authorized shutter opening/closing means 306 without an ID and a password. In a further embodiment, the user authentication may be implemented in such a way as to connect an authorized shutter opening/closing means 306 and receive an authorized ID and a password. The authentication of an authorized shutter opening/closing means and a genuine product is performed using the serial numbers of products stored in the Read Only Memory (ROM) of the, shutter opening/closing means 306. The private display control block 318 receives monitor information from a monitor information acquiring means 328, and controls an image data frame sequence generating means 322, a shutter opening/closing sequence and signal generating means 324, and a masking image generating means 326 on the basis of a user's authentication level and a display's security level. The monitor information acquiring means 328 reads information about the resolution of a monitor 304, refresh cycle time, vertical sync and horizontal sync.

The image data frame sequence generating means 322, the shutter opening/closing sequence and signal generating means 324 and the masking image generating means 326 generate an image data frame sequence, a shutter opening/closing sequence, and a masking image according to the user's authentication level, the display's security level and a user's additional selection, respectively. The shutter opening/closing sequence and signal generating means 324 generates a shutter opening/closing sequence in synchronization with the image data frame sequence, and generates a shutter opening/closing signal for a current time point in synchronization with the shutter opening/closing sequence.

The dedicated driver 310 provides a masking image generated in the masking image generating means 326 to video memory 340 according to the generated image data frame sequence, spontaneously generates a masking image according to the instruction of the masking image generating means 326 and provides the masking image to the video memory 340, or controls the change of a color table in real time. The dedicated driver 310 controls image transmission to the monitor 304 by making the video controller 312 switch the private image memory block and the masking image memory block according to the generated image sequence.

The transmission unit 308 transmits a shutter opening/closing signal to the shutter opening/closing means 306. The transmission unit 308 can transmit an encrypted shutter opening/closing signal to an authorized user using the encryption means (not shown). The transmission and reception units 308 and 336 can be implemented through a wired link, such as a Universal Serial Bus (USB) and a serial link, or a wireless link, such as an InfraRed (IR) link and a Radio Frequency (RF: Frequency Modulation (FM), Amplitude Modulation (AM) or Bluetooth) link. The video controller 312, such as a graphic card, is provided with video memory 340, and displays an original private image, which is received from the graphic driver 314, and a masking image, which is received from the dedicated driver 310, on the monitor 304 according the image data frame sequence.

As shown in FIG. 2, the shutter opening/closing means 306 includes a reception unit 336, a decoder/authentication means 330, a shutter controller 332 and a shutter 334. The reception unit 336 receives the encrypted shutter opening/closing signal transmitted from the transmission unit 308, and transmits the encrypted shutter opening/closing signal to the decoder/authentication means 330. The decoder/authentication means 330 acquires a shutter opening/closing sequence status value by decrypting the encrypted shutter opening/closing signal, and the shutter controller 332 maximally opens/closes or half opens (i.e. makes intermediate state) the shutter 334 according to the shutter opening/closing sequence status value.

In the shutter opening/closing signal communication of the present invention, communication is performed so that a shutter opening/closing sequence is generated depending on the P/M image sequence of the computer, and a shutter opening/closing sequence time point corresponding to a time point when a specific image is displayed on the computer is synchronized with an actual shutter opening/closing time point in a shutter. In the communication system among between the host computer 302, the transmission unit 308 and the reception unit 336 shown in FIG. 2, the transmission between the transmission and reception units of the present invention employs an arbitrary time transmission scheme which transmits a shutter opening/closing signal when the shutter status of the shutter opening/closing sequence is varied so as to prohibit a peeper having other shutters from detecting a shutter opening/closing time point, and additionally transmits a shutter opening/closing signal required to hold current shutter status at an arbitrary time point when the shutter status is not varied.

As an example of the shutter opening/closing signal communication according to the present invention, an encrypted shutter opening/closing signal is communicated so as to further prevent a peep action. In this communication, a large number of well-known encryption communication protocols can be used. Preferably, the communication includes an initializing process and a shutter opening/closing signal transmitting process. In the initializing process between the computer and the transmission unit, the transmission unit receives and stores monitor information, such as a refresh cycle time. In the initializing process between the transmission and reception units, an initialization protocol transmits a seed identical with that used to encrypt the shutter opening/closing signal by the computer to the reception unit, thus initializing the shutter. Preferably, the initialization is performed by a short burst, in which both a communication synchronization pattern and a seed used to establish a communication between the transmission and reception units are transmitted. As an example, a serial number stored in a Read Only Memory (ROM) of the shutter is utilized as a part of the seed to encrypt the shutter opening/closing signal and to allow only a shutter corresponding to the shutter opening/closing signal to decrypt the seed, thus authenticating the shutter. A protocol in the shutter opening/closing signal transmitting process is comprised of the broadcasts of a communication synchronization pattern and an encrypted shutter opening/closing signal.

In the shutter opening/closing signal communication of the present invention, a shutter opening/closing sequence time point corresponding to a time point when a specific image is displayed on the computer and an actual shutter opening/closing time point in the shutter should be synchronized with each other. If transmission delays including a transmission delay between the computer (exactly, the shutter opening/closing sequence and signal generating unit) and the transmission unit are insignificant, the time points correspond to each other.

Generally, the shutter opening/closing signal is transmitted in synchronization with vertical or horizontal synchronizing signal of the monitor or in synchronization with a data synchronizing signal in the case of asynchronous communication. At this time, a shutter opening/closing signal including a single shutter opening/closing sequence status value (status information), or a shutter opening/closing signal including a plurality of shutter opening/closing sequence status values can be transmitted with respect to one synchronizing signal.

In an embodiment of the present invention, if a shutter opening/closing signal including a piece of shutter opening/sequence status information is transmitted with respect to a one-time transmission, there are two embodiments: first embodiment in which the shutter opening/closing signal is transmitted at each shutter opening/closing sequence time point and the shutter is immediately operated depending on the state of the shutter opening/closing signal, and second embodiment in which the shutter opening/closing signal is transmitted in advance prior to each shutter opening/closing sequence time point by a certain sequence/period and the shutter is operated when the shutter opening/closing sequence time is reached.

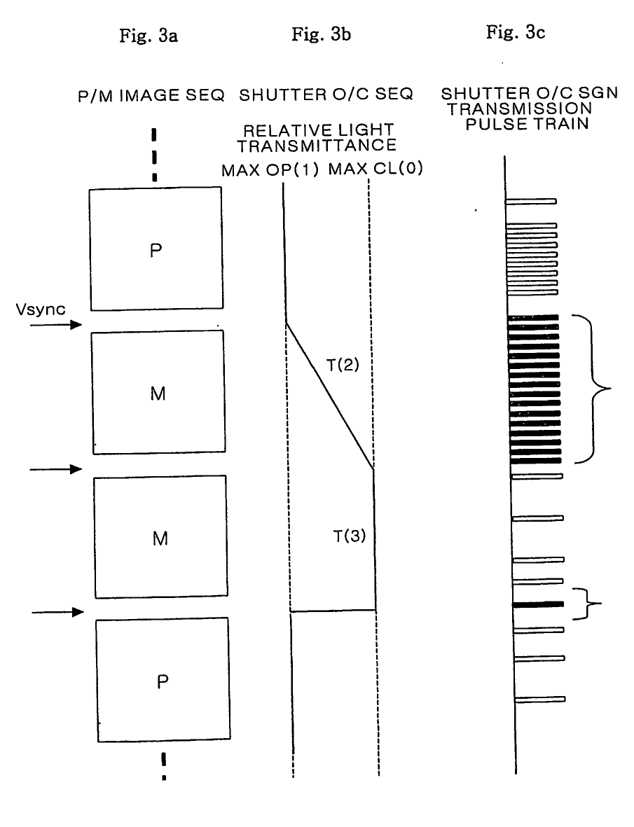

If the shutter opening/closing signal including a piece of shutter opening/closing sequence status information is transmitted with respect to a one-time transmission, the communication of the shutter opening/closing signal of the present invention is an arbitrary time transmission scheme which transmits a shutter opening/closing signal when the shutter status of the shutter opening/closing sequence is varied without providing a timer means in the shutter, which is a reception side, or without utilizing the timer of the shutter, and additionally transmits a shutter opening/closing signal required to hold current shutter status at an arbitrary time point when the shutter status is not varied. And the shutter opening/closing signal is encrypted and transmitted. In an embodiment of the present invention, a shutter opening/closing signal is transmitted only when the shutter status of the shutter opening/closing sequence is varied. In another embodiment thereof, a shutter opening/closing signal is transmitted when the shutter status of the shutter opening/closing sequence is varied, and a shutter opening/closing signal is additionally transmitted when the shutter status is not varied, but the status of P/M image frames (whether an image is P or M) is varied. In a further embodiment thereof, a shutter opening/closing signal is transmitted when the shutter status of the shutter opening/closing sequence is varied, and a shutter opening/closing signal is additionally transmitted at each vertical synchronizing signal of a monitor frame even through the shutter status is not varied. In still another embodiment thereof, a shutter opening/closing signal is transmitted when the shutter status of the shutter opening/closing sequence is varied, and a shutter opening/closing signal to hold current shutter status is additionally transmitted at an arbitrary moment that the shutter status is not varied. This embodiment is shown in FIGS. 3a to 3c. At a second monitor frame position, a shutter opening/closing sequence T(2) is fluctuated at various states for one period of the monitor frame. In the case of the shutter opening/closing sequence shown in FIG. 3b, shutter opening/closing signals are transmitted when the shutter status of the shutter opening/closing sequence is varied, and shutter opening/closing signals required to hold current shutter status are transmitted at an arbitrary moment that the shutter status is not varied, as shown in the transmission pulse train of the shutter opening/closing signal of FIG. 3c. In FIG. 3c, the shutter opening/closing signals when the shutter status is varied are represented by dark bars. At an arbitrary moment that the shutter status is not varied, the shutter opening/closing signals required to hold current shutter status are generated, encrypted and transmitted, which are represented by white bars. In the shutter opening/closing signals to hold current shutter status are transmitted asynchronously or in synchronization with a specific horizontal or vertical synchronizing signal Hsync or Vsync. If the method of transmitting the shutter opening/closing signals required to hold current shutter status at an arbitrary moment that the shutter status is not varied, is used even in a vertical synchronous scheme having a repetitive period, a peeper is prevented from intercepting and decrypting the shutter opening/closing signals in some degree. As an example, such a shutter opening/closing signal required to hold current shutter status may be a shutter opening/closing sequence status value corresponding to current shutter status or a shutter opening/closing status hold signal value, which is transmitted.

As another embodiment, if a shutter opening/closing signal including a plurality of pieces of shutter opening/closing sequence status information is transmitted with respect to a one-time transmission, a method according to one example includes the steps of transmitting a shutter opening/closing signal, in which a plurality of pieces of shutter opening/closing sequence status information are bundled, from the computer to the reception unit through the transmission unit at a specific shutter opening/closing sequence time point, the reception unit storing the bundle of the shutter opening/closing sequence status information, transmitting a shutter opening/closing instruction signal to the reception unit at each shutter opening/closing sequence time point, and the reception unit performing a shutter operation depending on the shutter opening/closing sequence status information stored in the reception unit when receiving the shutter opening/closing instruction signal. In this case, the shutter opening/closing instruction signal represents a signal for instructing a shutter opening/closing operation so as to open or close the shutter depending on a shutter opening/closing sequence status value decrypted using a previously received shutter opening/closing signal.

A method according to another example includes the steps of transmitting a shutter opening/closing signal, in which a plurality of pieces of shutter opening/closing sequence status information are bundled, from the computer to the transmission unit at a specific shutter opening/closing sequence time point, the transmission unit storing the bundle of the shutter opening/closing sequence status information, transmitting a shutter opening/closing instruction signal from the computer to the transmission unit at each shutter opening/closing sequence time point, and the transmission unit transmitting a shutter opening/closing signal for a shutter operation to the reception unit depending on the shutter opening/closing sequence status information stored in the transmission unit when receiving the shutter opening/closing instruction signal. The bundle of the shutter opening/closing sequence status information is represented in the form of [1,0,0,1,0] or [255,0,128,255,0] if, for example, five pieces of status information are bundled and transmitted. The shutter opening/closing instruction signal can be a simple pulse for instructing a shutter opening/closing operation. If the shutter opening/closing instruction signal is received, the shutter is operated using a status value corresponding to a current time point of the shutter opening/closing sequence status values, such as the stored [255, 0, 128, 255, 0].

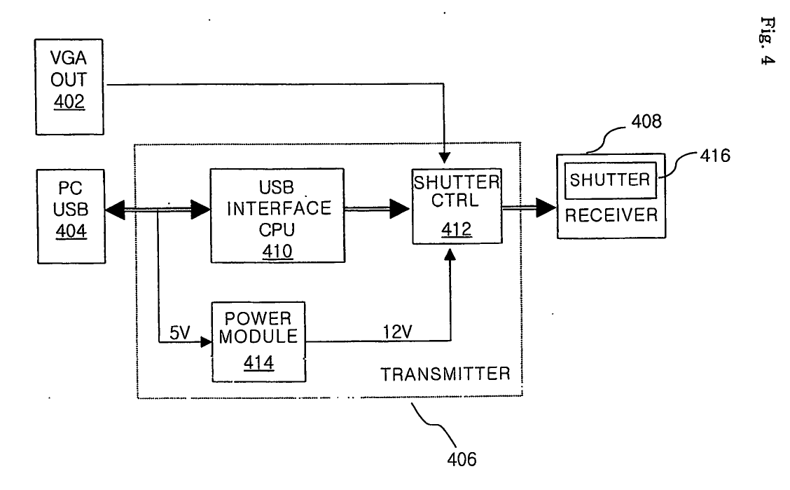

FIG. 4 is a block diagram of a system for compensating for a transmission delay using a monitor synchronizing signal according to the present invention. Communication interfaces can be implemented using wired links, such as USB, Institute of Electrical and Electronic Engineers (IEEE) 1394 and serial link, or wireless links, such as IR and RF (FM, AM, Bluetooth). FIG. 4 shows that a USB system 410 receives a signal for instructing information on whether to open or close a shutter and an extent to which the shutter is opened or closed from a USB port 404 of the computer in a USB wired link. The USB system 410 receives a voltage of +5V from the USB port 404 of the computer and boosts the voltage to +12V or +15V through a power module 414 to obtain a voltage required to control the shutter. A shutter controller 412 receives a control signal from the USB system 410 and then applies a voltage to a shutter 416. At this time, the shutter controller 412 receives both a vertical synchronizing signal Vsync and a horizontal synchronizing signal Hsync through a VGA output port 402 of the computer, and transmits the shutter opening/closing signal from the transmission unit to the reception unit in synchronization with the synchronizing signals, thus controlling the shutter 416. The control signal can be implemented using a modulation scheme, such as Pulse Width Modulation (hereinafter referred to as “PWM”), or a simple DC voltage.

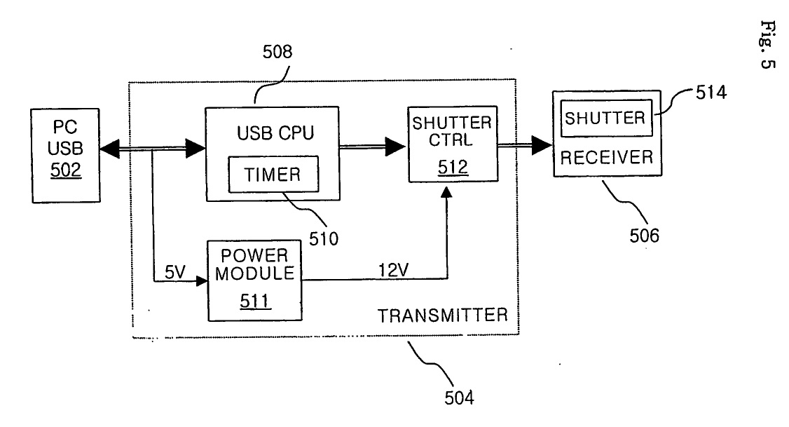

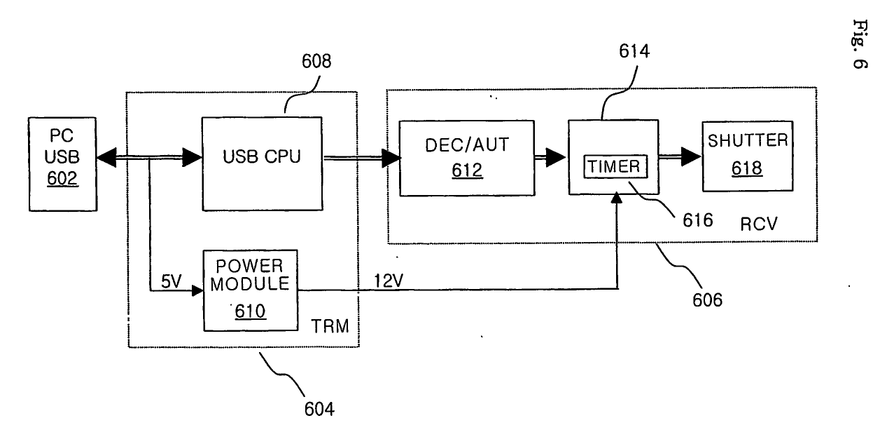

FIG. 5 is a block diagram of a system for compensating for a transmission delay using a timer of a transmission unit according to the present invention. In FIG. 5, a timer 510, included in a USB system 508, can be included in a shutter controller 512 or independently provided in a transmission unit 504. The operation of a timer 510 will be described later. The operations of other components are almost equal to those of corresponding components in FIG. 4. FIG. 6 is a block diagram of a system for compensating for a transmission delay using a timer of a reception unit according to the present invention. As shown in FIG. 6, a timer 616 is included in a shutter controller 614 of a reception unit 606, but it can be independently provided in the reception unit 606. The operation of the timer 616 will be described later. The operations of other components are almost equal to those of corresponding components in FIG. 4. A decoder/authentication means 612 is further provided in the reception unit 606, thus enabling only an authorized shutter device (user) to view a private image.

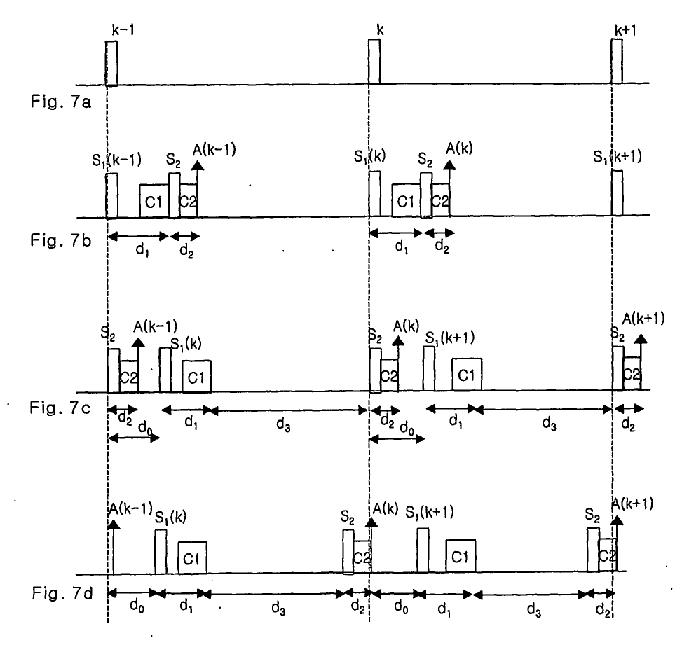

FIGS. 7a to 7d are signal waveform diagrams showing a method of compensating for a transmission delay according to the present invention. In FIG. 7a, a shutter opening/closing sequence time point generated by a computer is shown in the order of k−1, k and k+1. If the computer (exactly, a shutter opening/closing sequence and signal generating unit) transmits a shutter opening/closing signal to a reception unit through a transmission unit in synchronization with the shutter opening/closing sequence time point, a shutter opening/closing signal C₁(k) is transmitted at a time point k in synchronization with a transmission start signal S₁(k) transmitted from the computer to the transmission unit, as shown in FIG. 7b. At this time, due to the transmission delay of an operating system, the shutter opening/closing signal C₁(k) is issued with a delay, and an additional transmission delay may occur in the case of packet transmission as in the USB. The total transmission delay from the computer to the transmission unit is represented by d₁(k). The transmission unit transmits a shutter opening/closing signal C₂(k) to the reception unit in synchronization with a transmission start signal S₂(k). At this time, after a transmission delay d₂(k), a time point when the shutter is actually operated is A(k). The total transmission delay becomes d₁(k)+d₂(k). The shutter opening/closing signal C₂(k) is configured to be equal to the shutter opening/closing signal C₁(k), or to include only a part of the information of C₁(k).

If a transmission delay exists and is detected, compensation for the transmission delay is simple. If a transmission delay may be detected through a measurement or calculation, or if the transmission delay is constant, an embodiment, in which a computer transmits a shutter opening/closing signal to the transmission unit in advance prior to a shutter opening/closing sequence time point by the detected transmission delay and the transmission unit immediately transmits the shutter opening/closing signal to a reception unit, becomes identical with an embodiment in which a transmission delay does not exist.

If the operating system of the computer is not a real time operating system, such as MS Windows XP, 2000, 9x, a variable and unpredictable transmission delay occurs. In addition to the transmission delay, if packet transmission as in the USB is used, a transmission delay between the computer and the transmission unit becomes more difficult to detect and variable. In this case, a simple compensation is not easy.

If a transmission delay is not known and is varied, the monitor synchronizing signals (vertical and horizontal synchronizing signals) of the host computer are input to the transmission unit, and the transmission delay is compensated for using the monitor synchronizing signals in an embodiment of the present invention. In the embodiment of the present invention, when a shutter opening/closing sequence is generated in synchronization with the specific vertical or horizontal synchronizing signal of the host computer, the computer transmits a shutter opening/closing signal for a current time point in advance prior to an arbitrary time point, as shown in FIG. 7c, and the transmission unit stores the shutter opening/closing signal. In FIG. 7c, the computer transmits a shutter opening/closing signal for a time point k prior to the time point k by an arbitrary period d₁(k)+d₃(k). In this case, d₁(k) is a varying transmission delay between the computer and the transmission unit, and d₁(k)+d₃(k) is a preset arbitrary period. As an example, the shutter opening/closing signal for the time point k can be transmitted at a time point k−1, or at a time point k−n which is an arbitrary shutter opening/closing sequence time point before the time point k. The transmission unit transmits the stored shutter opening/closing signal to the reception unit in synchronization with the input vertical synchronizing signal or specific horizontal synchronizing signal. In an embodiment, a selecting unit for selecting a specific vertical or horizontal synchronizing signal among vertical or horizontal synchronizing signals input to the transmission unit is further included in the system. The selecting unit detects and selects a specific vertical or horizontal synchronizing signal corresponding to the shutter opening/closing sequence time point, and transmits the shutter opening/closing signal C₂(k) from the transmission unit to the reception unit in synchronization with the selected specific vertical or horizontal synchronizing signal. In this case, the selecting unit may require a timer or counter. In an embodiment of the present invention, a shutter opening/closing sequence time point is represented in the form of predetermined offset times based on vertical synchronizing signals and is included in the shutter opening/closing signal C₁(k) to be transmitted from the computer to the transmission unit. For example, the shutter includes the shutter opening/closing sequence time information in the shutter opening/closing signal C₁(k) in such a way that, if times a, b, c and d are reached after a current vertical synchronizing signal, the shutter is operated depending on status values [255, 0, 128, 0]. If the times a, b, c and d are reached using the timer or counter after the vertical synchronizing signal, the selecting unit synchronizes with the shutter opening/closing sequence time point by selecting a specific horizontal synchronizing signal. There may be a slight transmission delay between the transmission unit and reception unit at the time of encryption and transmission, but it is generally insignificant, so that an effect almost equal to that of an embodiment, in which a transmission delay does not exist, can be obtained if the above-described method is used.

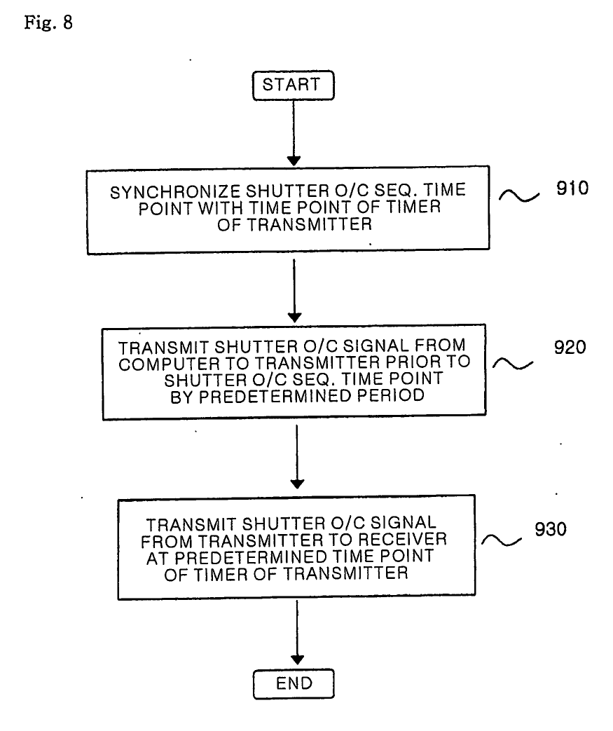

If a transmission delay is not known and is varied, in another embodiment of the present invention, the transmission delay is compensated for using the timer of the transmission unit. FIG. 8 is a flowchart of a method of compensating for a transmission delay using the timer of the transmission unit according to the present invention. First, the shutter opening/closing sequence time point of the computer and the time point of the timer of the transmission unit are synchronized with each other at step 910. The synchronization can be realized at a shutter initializing process, or continuously realized during a private image display operation.

If the shutter opening/closing sequence time point and the time point of the timer of the transmission unit are synchronized to some degree, the shutter opening/closing signal is transmitted to the transmission unit prior to the shutter opening/closing sequence time point by a predetermined period at step 920. As shown in FIG. 7d, the computer transmits the shutter opening/closing signal for a current time point to the transmission unit in advance prior to the current time point by an arbitrary period, and the transmission unit stores the shutter opening/closing signal. FIG. 7d shows that the computer transmits the shutter opening/closing signal C₁(k) for the time point k to the transmission unit in advance prior to the time point k by an arbitrary period d₁(k)+d₂(k)+d₃(k). In this case, d₂(k) is a transmission delay between the transmission unit and the reception unit and d₁(k)+d₂(k)+d₃(k) is the preset arbitrary time. In the above case, the shutter opening/closing signal for the time point k can be transmitted at a time point k−1, or at a time point k−n which is an arbitrary shutter opening/closing sequence time point before the time point k. The transmission unit transmits the stored shutter opening/closing signal C₂(k) to the reception unit at a predetermined time point according to a synchronizing signal issued by the timer of the transmission unit at step 930.

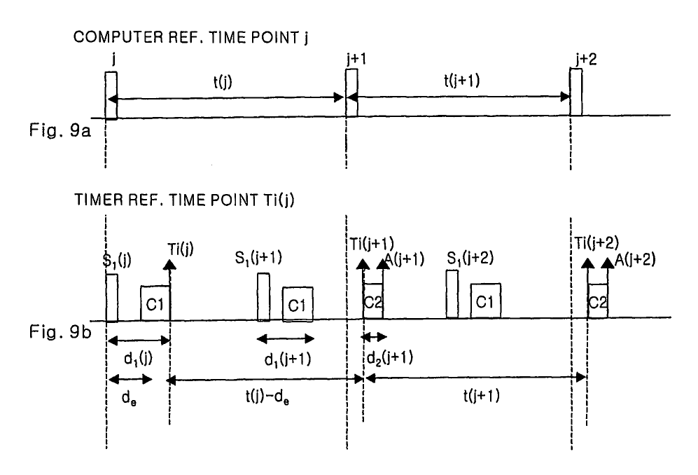

FIGS. 9a and 9b are signal waveform diagrams showing a method of synchronizing the time point of the timer of the transmission unit according to the present invention. In order to synchronize the time point in the present invention, a unknown transmission delay d₁(j)+d₂(j) at an arbitrary time point j is assumed to be a transmission delay prediction value dₑ, and the transmission delay corresponding to dₑ is compensated for. In FIG. 9a, shutter opening/closing sequence time points j, j+1, . . . are shown. In this case, when the time point j is the reference time point of the computer, the shutter opening/closing signal for synchronization is transmitted at the time point j. Then, as shown in FIG. 9b, the transmission unit receives the shutter opening/closing signal after the transmission delay d₁(j). This time point is set to the reference time point Tᵢ(j) of the timer of the transmission unit, at which the timer is initialized. Next, a shutter opening/closing signal C₁(j+1) for a time point j+1 is transmitted to the transmission unit in advance at an arbitrary time point prior to the time point j+1 by a period sufficiently longer than the transmission delay. For example, the shutter opening/closing signal for the time point j+1 can be transmitted at the time point j. If a time interval between the time point j and the time point j+1 is t(j), the timer of the transmission unit transmits a shutter opening/closing signal C₂(j+1) for the time point j+1 to the reception unit after the timer reference time point Ti(j) by a period {t(j)−de}. This time point denotes Ti (j+1). Thereafter, the shutter opening/closing signal is transmitted to the reception unit at a time point Ti(j+2) after the period t(j+1). Next, for an integer equal to or greater than 1, a shutter opening/closing signal is transmitted to the reception unit at a time point Ti(j+n+1) after the time point Ti(j+n) by a period t(j+n). During such a synchronizing process, time interval information t(j+n) between respective shutter opening/closing sequence time points must be transmitted from the computer to the transmission unit. For example, if a shutter opening/closing sequence is periodically generated as in the case of a vertical synchronization-type method, the time interval information t(j+n) is calculated using the refresh cycle time of the monitor information previously transmitted from the computer. As another example, if the shutter opening/closing sequence is generated at an arbitrary time point in synchronization with a specific horizontal synchronizing signal or asynchronously, shutter opening/closing sequence time points are not periodic, so that the computer transmits the time interval information t(j+n) to the transmission unit at a predetermined time point. During the synchronizing process, if the shutter opening/closing sequence is periodically generated as in the case of the vertical synchronization-type method, the timer of the transmission unit periodically issues a synchronizing signal S₂(k) for the transmission of the shutter opening/closing signal to the reception unit using the refresh cycle time of the monitor information previously transmitted from the computer. If the shutter opening/closing sequence is generated at an arbitrary time point in synchronization with a specific horizontal synchronizing signal or asynchronously, the shutter opening/closing time is not periodic, so that the shutter opening/closing signal to be transmitted from the computer to the transmission unit should include shutter opening/closing sequence time point information as well as shutter opening/closing sequence status information.

In this way, if the shutter is operated, a time difference between a shutter opening/closing sequence time point and an actual shutter opening/closing time point is consistently generated as a synchronous offset by the magnitude of {d₁(j)+d₂(j)−dₑ} at the reference time point because the transmission delay d₂ between the transmission and reception units is almost constant. If the difference between the transmission delay d₁(j)+d₂(j) and dₑ at the reference time point is not large, the user can easily view a private image. If the difference therebetween is large, the user cannot view a part of a private image or can view a masking image at a certain region. However, if the transmission delay is not compensated for, the time difference (synchronous offset) between the shutter opening/closing sequence time point and the actual shutter opening/closing time point is varied, so that the user views a screen on which a private image region vibrates vertically. However, if the transmission delay is compensated for, the time difference is fixed to a constant value at each time, so that the vibration of the private image is eliminated, thus realizing easy user visual perception. Further, if an additional compensation is performed by changing the transmission delay prediction value dₑ through user adjustment by a user interface, the user can easily view a private image. In order to reduce the synchronous offset, the transmission delay prediction value dₑ can be variously selected. For example, a transmission delay is tested for a sufficient period before the shutter is operated, and then a mean transmission delay value is calculated. A value adjacent to the mean transmission delay value is selected as the transmission delay prediction value dₑ. In order to minimize the synchronous offset, which is a transmission delay prediction error, the transmission delay prediction value dₑ is calculated on the basis of a prediction value dₘₑ at a specific time point having a smallest transmission delay prediction error in an embodiment of the present invention.

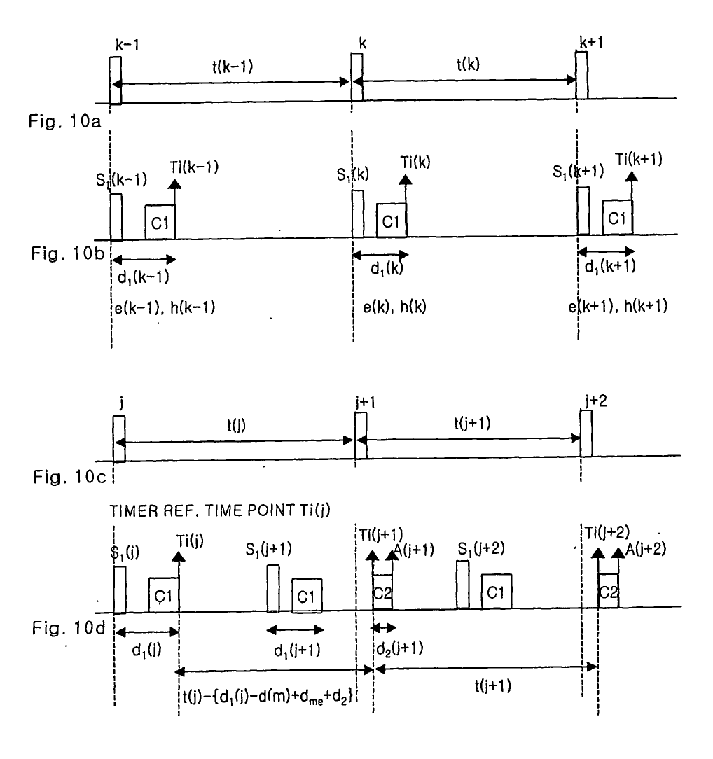

FIGS. 10a to 10d are signal waveform diagrams showing a method of synchronizing the time point of the timer of the transmission unit using difference compensation according to the present invention. In another embodiment for synchronization, a transmission delay is compensated for using difference compensation, such as Minimum Difference Summation (MDS) compensation. As an example, during a shutter initializing process, if a shutter opening/closing signal C₁(k) is transmitted to the transmission unit in synchronization with a shutter opening/closing sequence time point as shown in FIGS. 10a and 10b, the transmission unit receives the shutter opening/closing signal C₁(k) at the time points . . . , Ti(k), Ti(k+1), . . . of the timer thereof after respective transmission delays d₁(0), d₁(1), . . . , d₁(k−1), d₁(k), d₁(k+1), . . . . In this case, transmission delays cannot be simply measured. However, difference values between transmission delays e(1)=d₁(1)−d₁(0), . . . , e(k)=d₁(k)−d₁(k−1) can be simply measured using the respective time values Ti(k) of the timer of the transmission unit at respective time points. Further, a difference summation h(k) at an arbitrary time point k is calculated as

$$h ( k ) {\sum }_{i = 1}^{k} e ( i ) = {d}_{1} ( k ) - {d}_{1} ( 0 ) .$$

A difference summation at a time point 0 is defined by h(0)=d₁(0)−d₁(0)=0. First, a minimum value h(m) is searched for among respective difference summations during an initializing period. Then, a transmission delay d₁(m) is the minimum transmission delay at a time point m when the minimum difference summation h(m) exists. Generally, the minimum value d₁(m) of the transmission delays generated during a sufficient initializing period of approximately 1 second approaches a probable minimum transmission delay between the computer and the transmission unit. Therefore, if dₘₑ is a prediction value for the probable minimum transmission delay, dₘₑ˜=d₁(m) is satisfied.

As shown in FIGS. 10c and 10d, the computer transmits a shutter opening/closing signal C₁(j) for performing synchronization at a time point j by setting a computer reference time point to the time point j which is the last time of the initialization or an operation start time after the initialization. Thereafter, as shown in FIG. 10d, the transmission unit receives the shutter opening/closing signal C₁(j) after a transmission delay d₁(j). This time is set to the reference time point Ti(j) of the timer of the transmission unit, and the timer is initialized. Thereafter, a shutter opening/closing signal C₁(j+1) for a time point j+1 is transmitted to the transmission unit in advance at an arbitrary time point prior to the time point j+1 by a period sufficiently longer than the transmission delay. For example, the shutter opening/closing signal for the time point j+1 can be transmitted at the time point j.

If a time interval between the time point j and the time point j+1 is t(j), perfect compensation is performed when the timer of the transmission unit transmits the shutter opening/closing signal for the time point j+1 to the reception unit after the timer reference time point Ti(j) by a period {t(j)−(d₁(j)+d₂)}. Since dₘₑ˜=d₁(m), [t(j)−{d₁(j)+d₂}]˜=[t(j)−{d₁(j)−d₁(m)+dₘₑ+d₂}] is obtained. In this case, since h(j)−h(m)=d₁(j)−d₁(m) is obtained from a difference summation h(j)=d₁(j)−d₁(0) at the time point j, [t(j)−{d₁(j)−d₁(m)+dₘₑ+d₂}]=[t(j)−{h(j)−h(m)+dₘₑ+d₂}] is obtained. Each of d₁(j) and d₁(m) cannot be measured, but the difference summations h(j) and h(m) can be obtained using a calculation after difference values are measured. Therefore, if the timer of the transmission unit transmits a shutter opening/closing signal C₂(j+1) for the time point j+1 to the reception unit after the timer reference time point Ti(j) by a period [t(j)−{h(j)−h(m)+dₘₑ+d₂}], almost perfect compensation can be performed. The transmission start time is represented by Ti(j+1). At this time, a transmission delay prediction value satisfies dₑ=h(j)−h(m)+dₘₑ+d₂. In other words, the transmission delay prediction value dₑ and a prediction error Err at the reference time point j satisfy d₁(j)+d₂=dₑ+Err. The prediction value dₘₑ for the transmission delay d₁ between the computer and the transmission unit and the prediction error Err at a specific time point when the prediction error is smallest satisfy d₁(m)=dₘₑ+Err. A transmission delay is tested for a sufficient period before the shutter is operated, so that the prediction value dₘₑ at a time point when a prediction error is smallest can be selected. For example, a minimum transmission delay value measured for a sufficient period can be selected as dₘₑ. Since the prediction error Err, which is a synchronous offset, must be maintained at a constant level, Err−d₁(j)−dₑ+d₂=d₁(m)−dₘₑ is satisfied, thus obtaining dₑ=d₁(j)−d₁(m)+dₘₑ+d₂. If a difference summation is calculated, dₑ=h(j)−h(m)+dₘₑ+d₂ is obtained.

Next, a shutter opening/closing signal C₂(j+2) is transmitted to the reception unit at a time point Ti(j+2) after the period t(j+1). If the shutter is operated in this way, a time difference between a shutter opening/closing sequence time point and an actual shutter opening/closing time point is consistently generated by a constant magnitude of {d₁(m)−dₘₑ} because the transmission delay d₂ between the transmission and reception units is almost constant. Since dₘₑ˜=d₁(m), the time difference is insignificant, so that the user can conveniently view a private image. Further, if an additional compensation is performed by changing the minimum transmission delay prediction value dₑ through user adjustment by a user interface, the user can easily view a private image.

When the difference compensation, such as minimum difference summation compensation, is performed, the embodiment, in which a minimum transmission delay difference summation is calculated at a shutter initializing process and the time point of the timer of the transmission unit is synchronized after the initialization, is described above. However, a private display can be immediately operated without the shutter initializing process, and a transmission delay difference summation can be calculated and the synchronization of the timer can be performed during the operation of the private display.

As described above, even though the shutter opening/closing sequence time point based on the timer of the computer or the monitor synchronizing signal and the time point of the timer of the transmission unit are synchronized with each other, insignificant time errors are accumulated with the elapse of time, and then the time points may not be synchronous. For the factors causing this time error, there are noise, transmission error, and truncation error for time information transmitted by a computer, such as a refresh cycle time. In an embodiment of the present invention, the two time points are continuously synchronized with each other using difference compensation or the like during the operation of a private display.

If a transmission delay is not known and is varied, in another embodiment of the present invention, the transmission delay is compensated for using a timer of a reception unit. Since this embodiment is similar to that using the timer of the transmission unit, those skilled in the art can easily modify and implement the present invention.

### INDUSTRIAL APPLICABILITY

The present invention is advantageous in that, if a shutter opening/closing signal is transmitted from a private image display device to a shutter device, anti-peeper security performance is improved. Further, the present invention is advantageous in that a user visual perception performance can be improved by overcoming a transmission delay occurring when the shutter opening/closing signal is transmitted from the private image display device to the shutter device.

1. A method of transmitting a shutter opening/closing signal, the method transmitting the shutter opening/closing signal between a private image display device having a transmission unit, a shutter opening/closing sequence and signal generating unit and a monitor, and a shutter having a reception unit, comprising:
the shutter opening/closing sequence and signal generating unit generating a shutter opening/closing signal depending on an image sequence for a private image and a masking image;
the shutter opening/closing sequence and signal generating unit transmitting the shutter opening/closing signal to the transmission unit;
transmitting vertical or horizontal synchronizing signals input to the monitor to the transmission unit; and
the transmission unit synchronizing the shutter opening/closing signal with at least one of the input synchronizing signals and transmitting the synchronized shutter opening/closing signal to the reception unit.

2. The shutter opening/closing signal transmitting method according to claim 1, further comprising:
the shutter opening/closing sequence and signal generating unit transmitting a shutter opening/closing signal for a current shutter opening/closing sequence time point to the transmission unit in advance prior to the current sequence time point by a predetermined period; and
the transmission unit storing the shutter opening/closing signal.

3. The shutter opening/closing signal transmitting method according to claim 1, wherein the transmitting of the shutter opening/closing signal from the transmission unit to the reception unit comprises:
selecting a specific vertical or horizontal synchronizing signal corresponding to the shutter opening/closing sequence time point among the vertical or horizontal synchronizing signals input to the transmission unit; and
the transmission unit transmitting the shutter opening/closing signal to the reception unit in synchronization with the selected specific vertical or horizontal synchronizing signal.

4. A device for displaying a private image using a public monitor, the device being used together with a shutter device having a reception unit for receiving a shutter opening/closing signal, comprising:
masking image generating means generating a masking image for a private image;
means generating image sequence patterns for the private image and the masking image;
a shutter opening/closing sequence and signal generating unit generating both a shutter opening/closing sequence and a shutter opening/closing signal depending on the image sequence patterns; and
a transmission unit transmitting the shutter opening/closing signal to the reception unit to actually open or close the shutter device in synchronization with the shutter opening/closing sequence corresponding to an image to be displayed on the monitor.

5. The private image display device according to claim 4, wherein:
the transmission unit includes a timer;
the shutter opening/closing sequence and signal generating unit transmits a shutter opening/closing signal for performing synchronization at a time point j to the transmission unit, and the transmission unit initializes the timer by setting a reference time point T(j) of the timer to a time point when the shutter opening/closing signal for the synchronization is to be received;
the shutter opening/closing signal is transmitted in such a way that a shutter opening/closing signal for a time point j+n (where n is a natural number equal to or greater than 1) is transmitted to the transmission unit in advance prior to the time point j+n by a period sufficiently longer than a transmission delay;
the transmission unit transmits the received shutter opening/closing signal to the reception unit in such a way that, in the case where a time interval between a time point j+n−1 and the time point j+n is t(j+n−1), a received shutter opening/closing signal for a time point j+1 is transmitted, to the reception unit at a time point T(j+1) after the timer reference time point T(j) by a period {t(j)−de} (where de is a transmission delay prediction value) if n is 1, and a received shutter opening/closing signal for a time point j+n is transmitted to the reception unit at a time point T(j+n) after the timer reference time point T(j+n−1) by a period t(j+n−1) if n is equal to or greater than 2.

6. The private image display device according to claim 4, wherein:
the transmission unit includes a timer, and synchronizes a shutter opening/closing sequence time point generated by the shutter opening/closing sequence and signal generating unit with a time point of the timer;
the shutter opening/closing signal is transmitted to the transmission unit prior to the shutter opening/closing sequence time point by a predetermined period; and
the transmission unit transmits the shutter opening/closing signal to the reception unit at a predetermined time point of the timer.

7. The private image display device according to claim 4, wherein the transmission unit is operated so that, in the case where a shutter opening/closing signal including a piece of shutter opening/closing sequence status information is transmitted at the time of transmitting the shutter opening/closing signal to the reception unit once, the transmission unit transmits the shutter opening/closing signal when shutter status of the shutter device is varied, and additionally transmits a shutter opening/closing signal required to hold current shutter status even at an arbitrary time point when the shutter status is not varied.

8. The private image display device according to claim 4, wherein:
the shutter opening/closing sequence and signal generating unit is operated so that, in the case where a shutter opening/closing signal, in which a predetermined number of pieces of shutter opening/closing sequence status information are bundled, is transmitted to the reception unit when the transmission unit transmits the shutter opening/closing signal to the reception unit once, the shutter opening/closing sequence and signal generating unit transmits the shutter opening/closing signal, in which a predetermined number of pieces of shutter opening/closing sequence status information are bundled, to the reception unit through the transmission unit at a specific shutter opening/closing sequence time point; and
the reception unit stores the shutter opening/closing signal in which a predetermined number of pieces of shutter opening/closing sequence status information are bundled, and performs a shutter operation depending on the shutter opening/closing signal stored therein.

9. The private image display device according to claim 4, wherein:
the shutter opening/closing sequence and signal generating unit is operated so that, in the case where a shutter opening/closing signal, in which a predetermined number of pieces of shutter opening/closing sequence status information are bundled, is transmitted to the reception unit when the transmission unit transmits the shutter opening/closing signal to the reception unit once, the shutter opening/closing sequence and signal generating unit transmits the shutter opening/closing signal, in which a predetermined number of pieces of shutter opening/closing sequence status information are bundled, to the transmission unit at a specific shutter opening/closing sequence time point;
the transmission unit stores the shutter opening/closing signal in which a predetermined number of pieces of shutter opening/closing sequence status information are bundled; and
the shutter opening/closing sequence and signal generating unit transmits a shutter opening/closing instruction signal to the transmission unit at each shutter opening/closing sequence time point;
the transmission unit transmits a shutter opening/closing signal for a shutter operation to the reception unit according to the shutter opening/closing signal stored in the transmission unit when receiving the shutter opening/closing instruction signal.

10. A method of transmitting a shutter opening/closing signal from a device for displaying a private image to a shutter device using a public display, comprising:
generating a first shutter opening/closing signal when shutter opening/closing status of a shutter opening/closing sequence is varied;
generating a second shutter opening/closing signal at an arbitrary time point when the shutter opening/closing status of the shutter opening/closing sequence is held;
transmitting the first and second shutter opening/closing signals to the shutter device; and
opening or closing the shutter device depending on the received shutter opening/closing signals.

11. The shutter opening/closing signal transmitting method according to claim 10, wherein the first and second shutter opening/closing signals are transmitted to the shutter device prior to the shutter opening/closing sequence time point by a predetermined period.

12. A method of transmitting a shutter opening/closing signal from a device for displaying a private image to a shutter device using a public display, comprising:
generating both a shutter opening/closing signal including a bundle of shutter opening/closing sequence status information and a shutter opening/closing instruction signal for instructing the shutter device to be opened or closed;
transmitting the shutter opening/closing signal comprised of the bundle of the shutter opening/closing sequence status information obtained for a predetermined period to the shutter device;
transmitting the shutter opening/closing instruction signal to the shutter device at a shutter opening/closing sequence time point;
extracting shutter opening/closing sequence status information corresponding to a current time point from the received shutter opening/closing signal comprised of the bundle of the shutter opening/closing sequence status information when receiving the shutter opening/closing instruction signal, and opening or closing the shutter device depending on the shutter opening/closing sequence status information.

13. The shutter opening/closing signal transmitting method according to claim 12, wherein the shutter opening/closing signal comprised of the bundle of the shutter opening/closing sequence status information is transmitted prior to the shutter opening/closing sequence time point by a predetermined period.

14. A method of transmitting a shutter opening/closing signal between a private image display device including a transmission unit having a timer and a shutter opening/closing sequence and signal generating unit, and a shutter device including a reception unit, comprising:
synchronizing a shutter opening/closing sequence time point generated by the shutter opening/closing sequence and signal generating unit with a time point of the timer;
transmitting the shutter opening/closing signal to the transmission unit prior to the shutter opening/closing sequence time point by a predetermined period; and
transmitting the shutter opening/closing signal from the transmission unit to the reception unit at a predetermined time of the timer.

15. The shutter opening/closing signal transmitting method according to claim 14, wherein the synchronizing of the shutter opening/closing sequence time point comprises providing a user interface so as to allow a user to adjust a synchronous offset, and adjusting the synchronous offset depending on information input by the user through the user interface.

16. The shutter opening/closing signal transmitting method according to claim 14, wherein the synchronizing of the shutter opening/closing sequence time point is performed to have a constant synchronous offset at each time point.

17. The shutter opening/closing signal transmitting method according to claim 16, wherein the synchronous offset is set to have a minimum value.

18. The shutter opening/closing signal transmitting method according to claim 16, wherein the synchronizing of the shutter opening/closing sequence time point comprises:
transmitting the shutter opening/closing signal to the transmission unit at a predetermined shutter opening/closing sequence time point and initializing the timer by setting a reference time point of the timer to a time point when the transmission unit receives the shutter opening/closing signal;
compensating for the timer by predicting a transmission delay at the shutter opening/closing sequence time point as a predetermined transmission delay prediction value; and
the timer of the transmission unit generating a time point of the timer corresponding to the shutter opening/closing sequence time point using time interval information between shutter opening/closing sequence time points.

19. The shutter opening/closing signal transmitting method according to claim 18, wherein the transmission delay prediction value uses a value adjacent to a mean transmission delay value.

20. The shutter opening/closing signal transmitting method according to claim 18, wherein the transmission delay prediction value is calculated using a prediction value at a shutter opening/closing sequence time point having a smallest transmission delay prediction error.

21. The shutter opening/closing signal transmitting method according to claim 18, wherein the transmission delay prediction value is calculated using a prediction value at a shutter opening/closing sequence time point when a minimum or maximum transmission delay occurs for a predetermined period.

22. The shutter opening/closing signal transmitting method according to claim 20, wherein the calculation is performed using a difference value between a transmission delay at a shutter opening/closing sequence time point having a smallest transmission delay prediction error and a transmission delay at the set reference time point.

23. The shutter opening/closing signal transmitting method according to claim 20, wherein the calculation is performed using a difference summation of transmission delays obtained for a predetermined period.

24. A method of transmitting a shutter opening/closing signal between a private image display device including a transmission unit and a shutter opening/closing sequence and signal generating unit, and a shutter device including a reception unit having a timer, comprising:
synchronizing a sequence time point of a shutter opening/closing signal generated by the shutter opening/closing sequence and signal generating unit with a time point of the timer;
transmitting the shutter opening/closing signal to the reception unit through the transmission unit prior to the shutter opening/closing sequence time point by a predetermined period; and
opening or closing the shutter device depending on the received shutter opening/closing signal at a predetermined time point of the timer.
